(19) United States
(12) Patent Application Publication
(10) Pub. No.: US 2015/0206191 A1
(43) Pub. Date: Jul. 23, 2015

(54) SYNDICATED ADVERTISING AND COMMERCE THROUGH WIDGETS

(71) Applicant: Microsoft Technology Licensing, LLC, Redmond, WA (US)

(72) Inventor: DAMON VINCENT DANIELI, BELLEVUE, WA (US)

(21) Appl. No.: 14/676,250

(22) Filed: Apr. 1, 2015

Related U.S. Application Data
(63) Continuation of application No. 12/209,034, filed on Sep. 11, 2008, now abandoned.

(51) Int. Cl. G06Q 30/02; G06F 17/22; G06F 3/0484

(52) U.S. Cl. CPC G06Q 30/0267; G06F 3/0484; G06F 17/2247; G06F 17/2235

(57) ABSTRACT

An Internet host user posts, or embeds an advertising link, or widget into an interactive program located on a website. The advertising link is viewed by other users who visit the website and participate in the interactive program. A backend infrastructure provides servicing for the interactive program, and is also the source of the advertising links. A host user selects the advertising link from an inventory of advertising links provided by the infrastructure. The infrastructure provides free servicing of the interactive program to the host user in exchange for posting its advertising links.

### CROSS-REFERENCE TO RELATED APPLICATIONS

This application is a continuation of U.S. application Ser. No. 12/209,034, filed Sep. 11, 2008, which is hereby incorporated by reference in its entirety.

### BACKGROUND

The Internet is an interconnected computer network that provides an enormous communication medium. Large Internet-based companies have the information technology (IT) equipment and human resources to provide service to millions of users of their Internet websites and resources. A great deal of this IT support is funded through advertising. Advertising sponsors of a large Internet-based company provide a substantial portion of funding because these large companies reach a large number of users.

People are using the Internet for more and more activities, ranging from purely business activities to purely recreational activities. The Internet provides a huge source of advertising. A commonly used method of advertising utilizes a central advertising source. This central advertising source places or embeds advertising links on Internet pages accessed by users. For example, a free search engine may provide users access for searching websites, and the results of search queries could be displayed along with advertisements selected by a backend advertising service. Or, in another example, a free e-mail service may be configured to show advertisements to users checking their e-mail.

Similarly, when a user browses, advertisements may be displayed in various portions of a website. If the website attracts a large number of users, the advertising links are likely to receive a large number of hits. This advertising approach requires a great deal of management and maintenance from a centralized server.

Smaller Internet-based companies and individuals cannot provide an Internet servicing function that is necessary for many Internet activities. The cost of IT equipment and human support limits the level of Internet activity available. Therefore, the Internet activity is limited and as a result, fewer users are attracted to that resource or website. Many advertisers are also not interested in working with smaller companies and individuals since the return on their investment is much smaller.

### BRIEF SUMMARY

The subject matter described herein is presented with specificity to meet statutory requirements. The description herein, however, is not intended to limit the scope of this patent. Rather, it is contemplated that the claimed subject matter might also be embodied in other ways, to include different steps or combinations of steps similar to the ones described in this document, in conjunction with other present or future technologies. Moreover, although the term “block” may be used herein to connote different elements of methods employed, the term should not be interpreted as implying any particular order among or between various steps herein disclosed.

One aspect of the invention is directed to providing free or subsidized Internet resources for less frequently used websites. A host user selects an interactive program widget from an inventory of widgets provided by a backend advertising infrastructure, which manages advertisements on one or more servers. A host user posts, or embeds, an interactive program widget into his or her webpage. The widget is viewed by other users who visit the webpage, and the host user receives free or subsidized support of the interactive program from a backend infrastructure.

The backend infrastructure provides servicing for the interactive program, and is also the source of the advertising links. In exchange for the ad display space on the user's webpage, the infrastructure provides a free Internet service or a portion of the revenues received by the interactive program widget to the host user.

This peer-to-peer advertising system promotes the sponsored advertising of the backend infrastructure in a direct user-to-user approach. The viewer of the first user's widget can copy, configure, and embed the widget onto their own page. Now we have two interactive program widgets displaying the advertisements. The infrastructure plays an indirect role in the advertising. This advertising system also allows the infrastructure to monitor, or track usage of the widgets and to gather analytical information regarding user patterns.

### BRIEF DESCRIPTION OF THE SEVERAL VIEWS OF THE DRAWINGS

The present invention is described in detail below with reference to the attached drawing figures, wherein:

FIG. 1 illustrates a block diagram of an exemplary operating environment for use in implementing an embodiment of the present invention;

FIG. 2 illustrates a block diagram of an Internet-based advertising arrangement for use in implementing an embodiment of the present invention;

FIG. 3 illustrates a block diagram of an interactive computer program, according to an embodiment of the present invention;

FIG. 4 illustrates a block diagram of an interactive computer program, according to an embodiment of the present invention;

FIG. 5 illustrates a flowchart of an interactive computer program, according to an embodiment of the present invention;

FIG. 6 illustrates a block diagram of an interactive computer program, according to an embodiment of the present invention;

FIG. 7 illustrates a block diagram of an interactive computer program, according to an embodiment of the present invention;

FIG. 8 illustrates a block diagram of an interactive computer program, according to an embodiment of the present invention; and

FIG. 9 illustrates an exemplary web page with an interactive computer program, according to an embodiment of the present invention.

### DETAILED DESCRIPTION

The subject matter described herein is presented with specificity to meet statutory requirements. The description herein, however, is not intended to limit the scope of this patent. Rather, it is contemplated that the claimed subject matter might also be embodied in other ways, to include different steps or combinations of steps similar to the ones described in this document, in conjunction with other present or future technologies. Moreover, although the term “block” may be used herein to connote different elements of methods employed, the term should not be interpreted as implying any particular order among or between various steps herein disclosed.

One embodiment of the invention uses the information technology (IT) overhead provided by a large Internet-based infrastructure for servicing support, such as authentication of users and interconnections between users. The invention also taps into the large inventory of sponsored advertisers of the infrastructure. This overhead servicing support and sponsored advertisers are provided to smaller entity Internet users through subcontracted advertising.

A small Internet host user can provide an interactive computer program, embodied on computer-readable media, onto any one of a personal web page, a business website, a collaborative website which is commonly known as a wiki, or an online journal website which is commonly known as a web blog. This interactive program can be provided as a complementary activity to other users through a communications system of subcontracted advertising and/or commerce.

This communications system uses a graphical user interface component called a “widget.” A “widget,” as referred to herein, is a portion of software—which can be embedded within a web page—configured to allow users to communicate over the Internet, or other network. Widgets may include a specific user-interface graphic control—in addition to a badge—such as a button, box, entry field, drop-down list, cascade menu, or the like. The widget may be implemented using a plugin to a web browser, for example, by using an ActiveX control, Mozilla plugin, asynchronous JavaScript and extensible markup language (AJAX) program, or the like. Widgets may be copied and pasted from web page to web page. Moreover, widgets may include different visual skins called “badges,” which are displays of content on the widget, such as an advertisement, online review, image, or video.

Widgets may be configured to enable users to communicate in a number of ways. For example, a widget may facilitate a phone call over a voice over Internet protocol (VOIP) network. A widget may provide an avenue for setting up a multiplayer game. Widgets may also take the form of online business cards that allow users to contact a person through an e-mail service, text messaging, instant messaging, or the like. In one embodiment, the widget is a travelogue that displays pictures saved on a mobile phone and allows viewers to contact the mobile-phone owner by simply clicking on a displayed picture. In another embodiment, the widget is a family calendar that automatically synchronizes two user's electronic calendars. In still another embodiment, the widget enables an online meeting. Other widgets are also possible and should be readily apparent to one of skill in the art. In summary, the widget is distributing “functionality” across the Internet in the form of communication, and in exchange for the communication, revenue is collected by the hosting web page's operator or owner for advertisements being presented within the badges of the widget.

In one embodiment, a backend infrastructure of servers provides authentication and connectivity of users, as well as management and placement of online advertisements. The backend infrastructure may also monitor click-thrus of advertisements and gather various other web analytics. Specifically, the backend infrastructure provides numerous services, such as authentication and authorization of users, network address translation (NAT) traversal and media relay, advertisement inventory, web analytics and tracking, communication services (e.g., conference bridges, voice mail, instant message, text message, music mixing, etc.), and other communication services—many of which will be known those of skill in the art.

In one embodiment, the widget contains advertising, products and/or services from one of many sponsored providers of the backend infrastructure. The widget may be encompassed in an interactive program that is embedded in a web page that can be accessed by browsing users. The browsing users are afforded an opportunity to pursue the products and/or services being advertised or supported by the backend infrastructure. In exchange for advertising, the host user may receive complementary servicing for the interactive program from the servicing infrastructure company.

As one skilled in the art will appreciate, embodiments of the present invention may be embodied as, among other things: a method, system, GUI, or computer-program product that is embodied on one or more tangible computer-readable media. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media. Computer-readable media include both volatile and nonvolatile media as well as removable and nonremovable media.

By way of example, and not limitation, computer-readable media comprise computer-storage media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read-only memory (ROM), electrically erasable programmable read-only memory (EEPROM), flash memory used independently from or in conjunction with different storage media, such as, for example, compact-disc read-only memory (CD-ROM), digital versatile discs (DVD), holographic media or other optical disc storage, magnetic cassettes, magnetic tape, magnetic disk storage, or other magnetic storage devices. These memory components can store data momentarily, temporarily, or permanently.

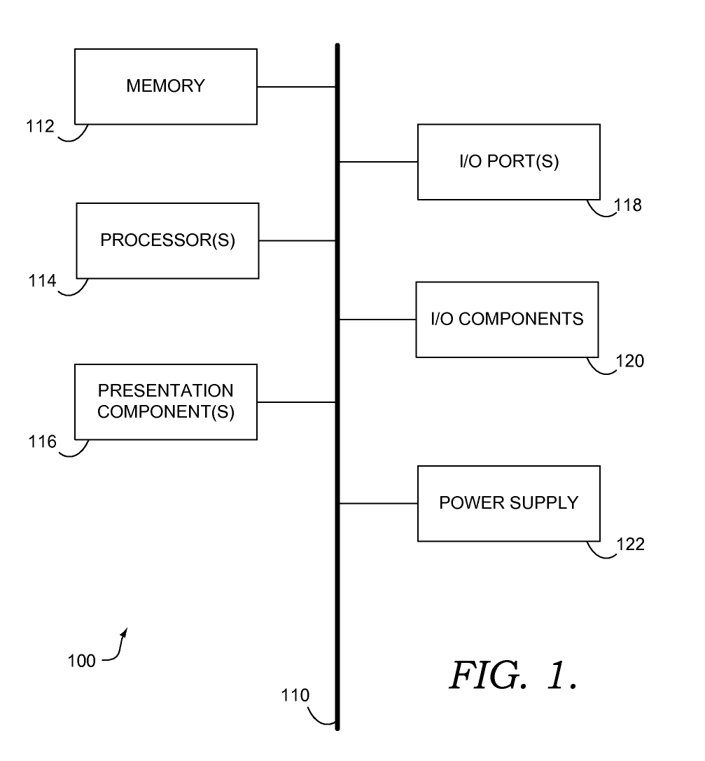

Having briefly described a general overview of the embodiments described herein, an exemplary computing device is described below. Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In one embodiment, computing device 100 is a conventional computer (e.g., a personal computer or laptop).

One embodiment of the invention may be described in the general context of computer code or machine-useable instructions, including computer-executable instructions such as program modules, being executed by a computer or other machine. Generally, program modules including routines, programs, objects, components, data structures, and the like refer to code that perform particular tasks or implement particular abstract data types. Embodiments described herein may be practiced in a variety of system conFIGurations, including handheld devices, consumer electronics, general-purpose computers, more specialty computing devices, etc. Embodiments described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 typically includes a variety of computer-readable media. By way of example, and not limitation, computer-readable media may comprise RAM; ROM; EEPROM; flash memory or other memory technologies; CDROM, DVD or other optical or holographic media; magnetic cassettes, magnetic tape, magnetic disk storage or other magnetic storage devices, or similar tangible media that are conFIGurable to store data and/or instructions relevant to the embodiments described herein.

Memory 112 includes computer-storage media in the form of volatile and/or nonvolatile memory. The memory may be removable, nonremovable, or a combination thereof. Exemplary hardware devices include solid-state memory, hard drives, cache, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

The components described above in relation to computing device 100 may also be included in a mobile device. A mobile device, as described herein, refers to any type of mobile phone, handheld device, personal digital assistant (PDA), BlackBerry®, smartphone, digital camera, or other mobile devices (aside from a laptop) capable of communicating wirelessly. One skilled in the art will appreciate that mobile devices will also include a processor and computer-storage media to perform various functions. Embodiments described herein mention to both a computing device and a mobile device. In embodiments, computing devices merely refer to devices that are running applications of which images are captured by the camera in a mobile device.

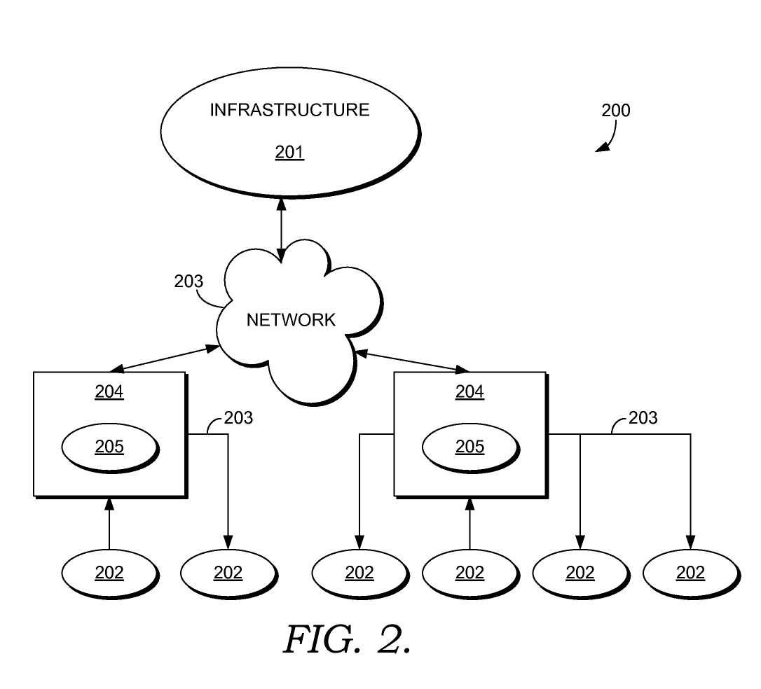

A communications system 200 is illustrated in FIG. 2, in accordance with an embodiment of the invention. A servicing infrastructure 201 provides large-scale servicing to many small and individual users 202. Instead of a centralized advertising agency, the communications system 200 places the role of advertising between users 202 through the use of an interconnected computer network 203, which is commonly known as the Internet. Internet services, tools, and resources of an individual host user 202 are made available to other users 202 through advertising sponsors. In one embodiment, the advertising sponsors upload their advertisements to servers, or other computing device, of the backend, servicing infrastructure 201. An advertisement from one of these advertising sponsors is embedded into an interactive program 204, in the form of a widget 205.

There are many possible types of interactive programs 204 in which the communications system 200 can be embodied. A user 202 can develop his/her own template that contains the logic, artwork, rules, applications, etc., or pre-created templates can be obtained from a vendor. These templates may be used in the interactive program 204.

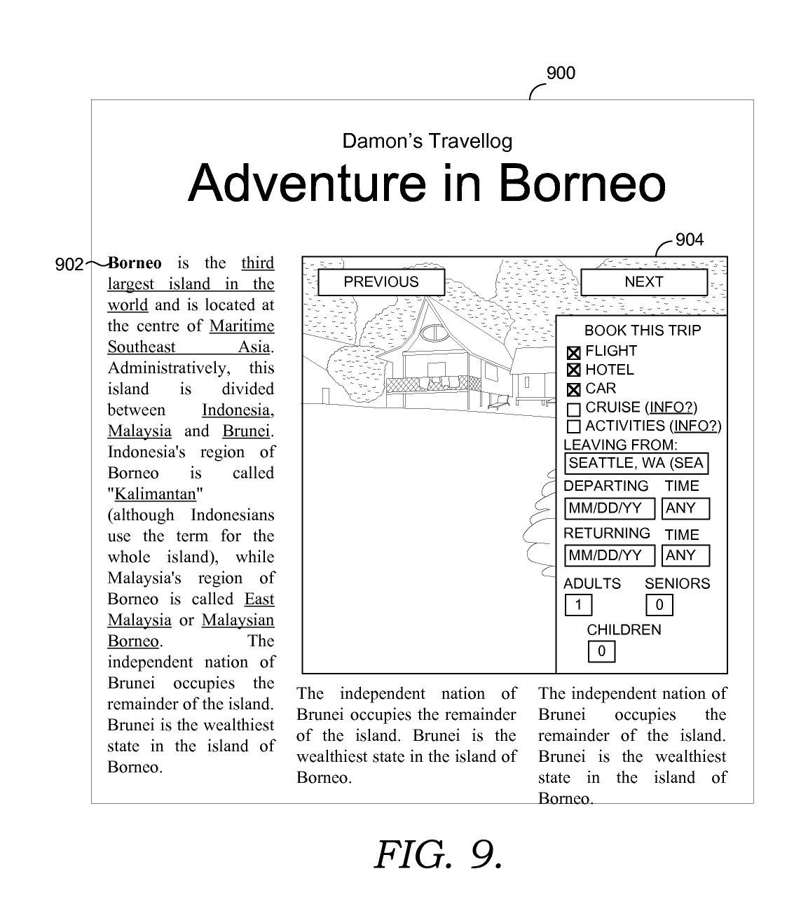

In one embodiment, the interactive program 204 is a vacation package ordering system. A host user 202 (e.g., an operator or owner of a web page) can post a vacation ordering system into the interactive computer program 204 on a personal webpage. An example of a user interface for this particular embodiment is shown in FIG. 9. The user has created a web log (blog 900) post about their vacation to Borneo. The blog 900 includes text 902 about the user's experiences. The blog 900 also includes an embedded vacation-package widget 904. In this embodiment, the vacation-package widget 904 has been specifically conFIGured by the operator of the blog 900 to show slides of a trip to Borneo and sell travel packages to the location the operator went. The vacation-package widget 904 may also allow visitors to book reservations at a specific hotel (e.g., the hotel the operator stayed at), make car reservations from a specific rental-car company, or provide a gateway to other businesses that were used by the operator. In one embodiment, the backend infrastructure has aggregated all of the products and services on one or more servers that can be accessed through the widget 904. Advertising space on the widget 904 can be sold by the operator to the infrastructure provider, and the infrastructure provider can, in turn, charge fees from the various advertisers (e.g., hotels, car-rental companies, etc.) it supports. In this embodiment, the operator may essentially receive advertising fees (e.g., by the impression or through click-through rates) from the various advertisers via the infrastructure provider.

When a user 202 visits the web page, which contains the interactive program 204, the phone number will appear with an option to dial that number. When the phone number is dialed by a visiting user 202, communication is carried out between the host user 202 and the visiting user 202 via their computer microphones and speakers. For example, the communication may handled as a VOIP phone call. During the call, the visiting user 202 will have the opportunity to view various widgets 205 that appear subsequent to clicking upon the phone number. If the visiting user 202 is interested in any of the widgets 205, or advertisements in the badges of the widgets 205, that appear, the visiting user 202 may add the advertisements to a call list for contacting, subsequent to the phone call between users 202.

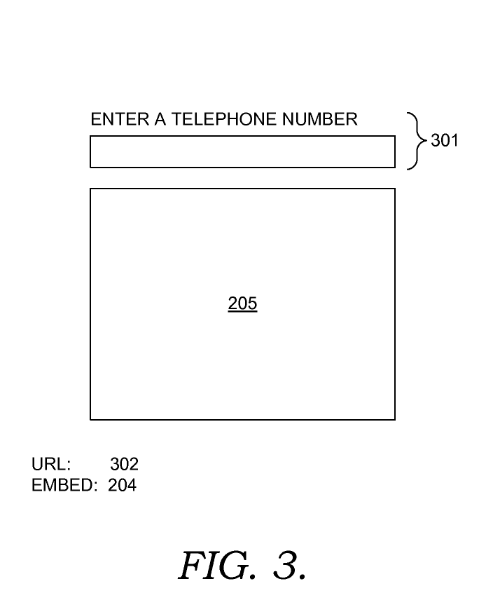

In another embodiment, the interactive program 204 supports a telephonic conversation. A host user 202 may post a phone number into the interactive computer program 204 on a business or personal webpage. An example of the computer screen format to set up this particular embodiment is shown in FIG. 3. The phone number to be contacted is entered into field 301. A contact URL 302 and the interactive program 204 are selected as the location or site for posting the phone number. In one embodiment, when a user 202 visits the web page with the interactive program 204 that was posted by the host user 202, the phone number will appear with an option to contact that number. When the phone number is contacted by a visiting user 202, communication is carried out between the host user 202 and the visiting user 202 via their computer microphones and speakers. During the call, the visiting user 202 will have the opportunity to view various widgets 205 that appear subsequent to clicking on the phone number. If the visiting user 202 is interested in any of the widgets 205, or advertisements in the badges of the widgets 205, that appear, the visiting user 202 may add the advertisements to a call list for contacting, subsequent to the phone call between users 202.

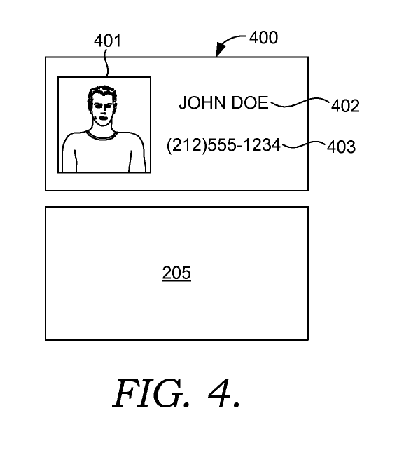

In another embodiment, the interactive program 204 is an electronic business card 400, which is illustrated in FIG. 4. After signing into an online account, a host user 202 may select a pre-created business card template. The template will prompt the user for information, such as an image 401 to use, name 402, and phone number 403. The embedded URL 302 can be pasted onto the website of the interactive program 204. The visiting user 202 could click on the contact link to send a text message or call the contact phone number. When a connection to the embedded URL 302 is made, the user 202 would subsequently have the opportunity to view various widgets 205 A particular widget 205 could be pursued during the contacting of the phone number or URL 302, or an option to pursue the widget 205 after making the contact may also be given.

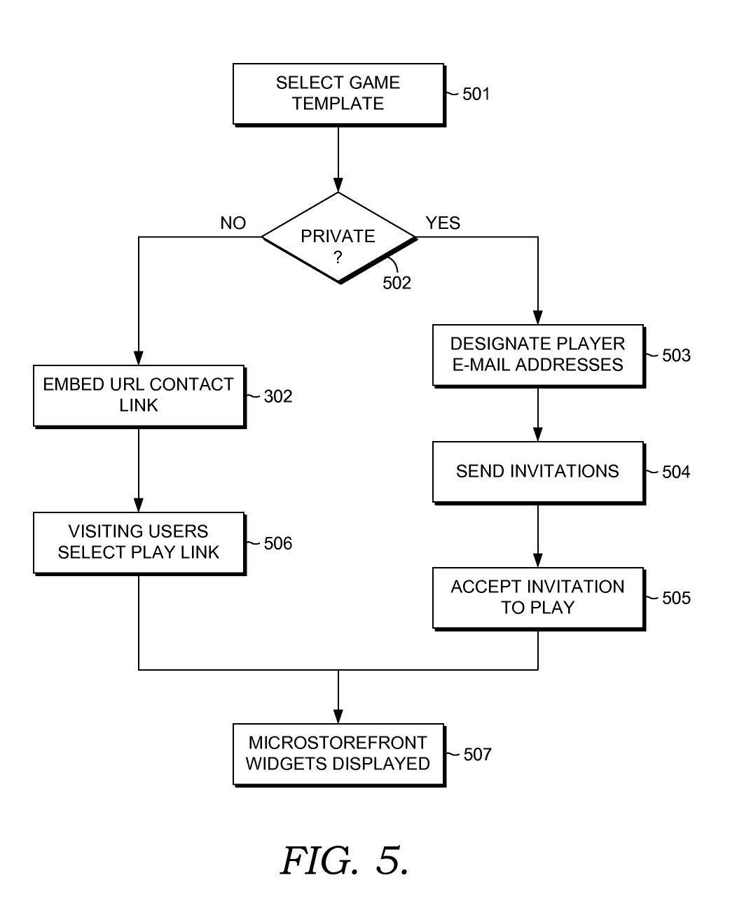

Another embodiment of the interactive program 204 is a multiplayer game with the functionality described in the flow chart of FIG. 5. The host user 202 may sign into an online account (e.g., a Windows Live™ account) and select a pre-created game template, as indicated at 501. The interactive program 204 can be set up as a private game 502 in which individual users 202 are selected (indicated at 503), invited to participate (504), and accept that invitation to play (505). In contrast, a URL 302 contact may be provided allowing any user 202 visiting the site to click upon the linked contact 506 and participate. When the URL 302 contact is made, widgets 205 are displayed (507) for the user 202 to view.

In another embodiment, the interactive program 204 is a mobile phone contact system. A picture or image, such as a portrait picture, may be uploaded by a host mobile phone user, and sent to other mobile phone users. Other mobile phone users could download the picture or image onto their mobile phones. Clicking on the downloaded picture or image would connect the mobile phone user to the host mobile phone user.

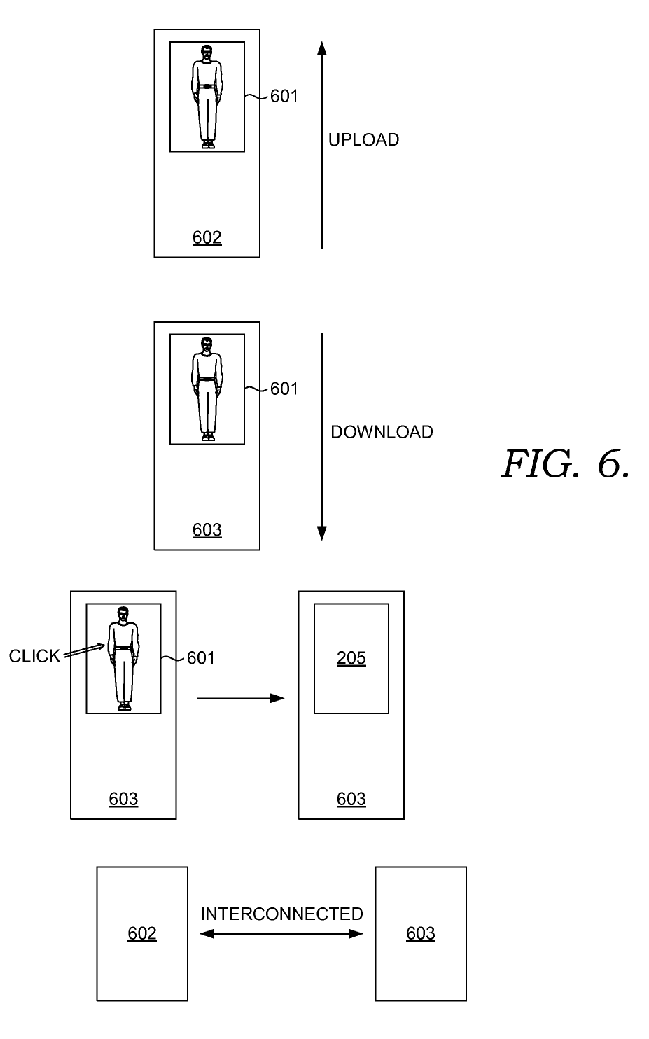

As illustrated in the embodiment depicted in FIG. 6, a picture or image 601 could be uploaded from a first mobile phone 602 and sent to a second mobile phone 603. The second mobile phone 603 user could download the picture or image 601 onto the second mobile phone 603. When the second user desires to contact the first user, the second user may click on the downloaded image or picture 601, thus initiating communication between the users. During communication, badges of the widgets 205 are displayed on the screen of the second—or “calling”—mobile phone 603.

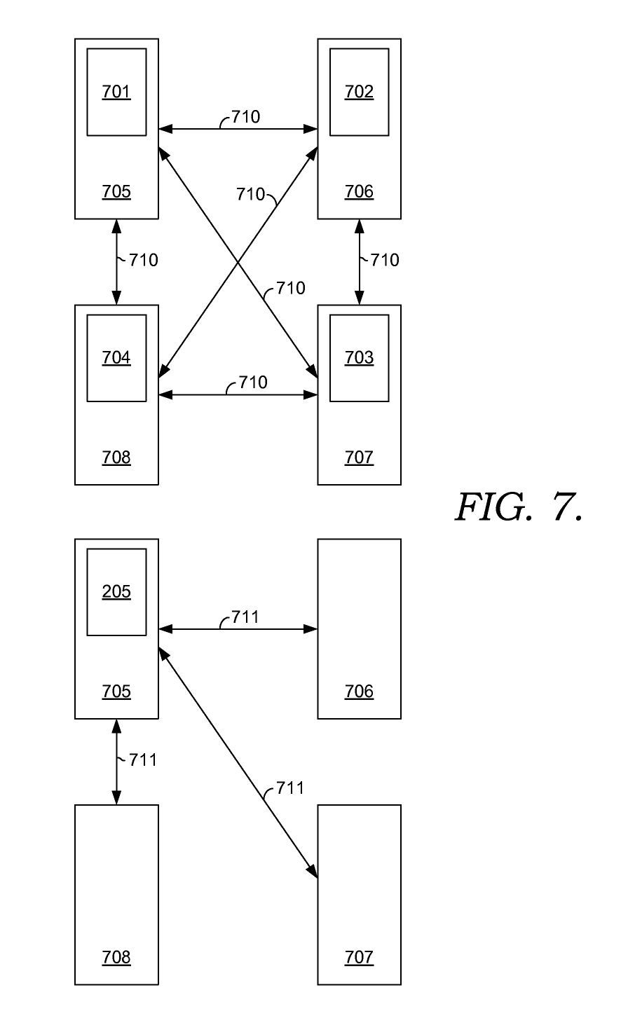

The interactive program 204 may also take the form of a mobile phone group calendar. Members of a group (e.g., a family, group of friends, work group, etc.) can have the calendars on their mobile phones synchronized using various synchronization software (e.g., Microsoft ActiveSync®). After synchronization, any addition, deletion, or amendment to one member's calendar would be automatically made to the rest of the members' calendars. As illustrated in FIG. 7, a first calendar 701 on a first mobile phone 705 is synchronized (710) to each of a second calendar 702, a third calendar 703, and a fourth calendar 704 located upon a second mobile phone 706, a third mobile phone 707, and a fourth mobile phone 708, respectively. Likewise, the second, third, and fourth calendars 702, 703, and 704 are each synchronized (710) to other calendars.

In one embodiment, when a change, such as an addition, deletion, or amendment to any of the calendars 701, 702, 703, or 704 is initiated, a widget 205 will be displayed on the screen of the mobile phone that initiated the calendar change. The widget 205 will continue to be displayed on the screen while the calendar change is being processed (711) to the synchronized calendars. An example of such a change is shown in FIG. 7. A calendar change is initiated to the first calendar 701 of the first mobile phone 705. While that change is being processed (711) to the second, third, and fourth calendars 702, 703, 704 of the second, third, and fourth mobile phones 706, 707, 708, respectively, widgets 205 continue to appear on the screen of the first mobile phone 705.

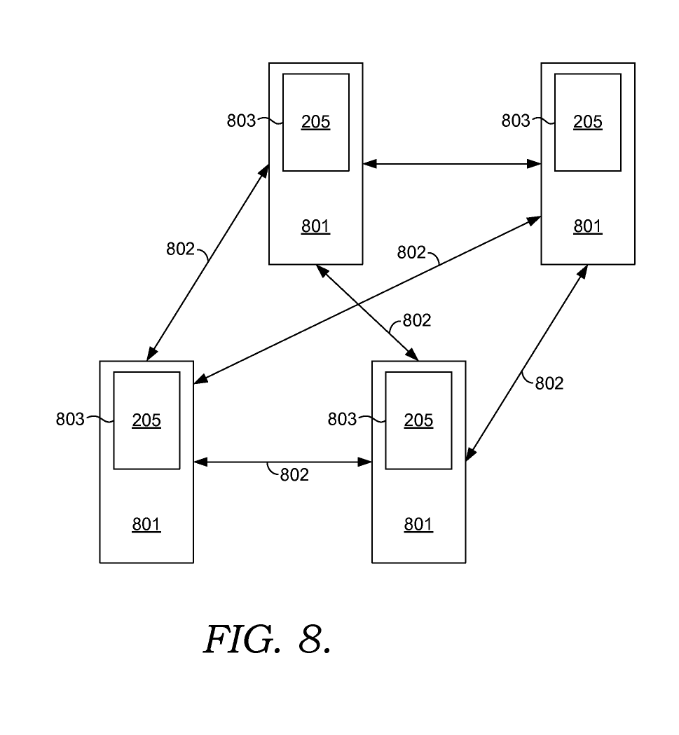

In another embodiment, the interactive program 204 is an online meeting room, as illustrated in FIG. 8. An interactive business or personal meeting could take place between meeting participants via an Internet website or by mobile phone 801 via wireless communication 802. While a meeting discussion between participants is occurring, the computer or mobile phone screens 803 display widgets 205.

Many other embodiments of the interactive computer program and other components of the communications system described herein would be obvious to those of ordinary skill in the art. The embodiments described herein are by way of illustration only, and the invention is not meant to be limited to those described embodiments.

The communications system described herein provides advantages to both the servicing infrastructure company and to all of the users of the communications system. The servicing infrastructure company has the capability to expand its advertising audience to a large pool of smaller unknown Internet sites and users that would have remained untapped with conventional advertising only. In addition to expanding its advertising audience, the servicing infrastructure is also able to track this large pool of users, and thereby obtain analytical information for additional marketing purposes.

The communications system described herein provides smaller entity users with the backend service of a large infrastructure. This in turn provides these users with Internet tools, services, and resources of a higher caliber for free or at a reduced cost.

The invention claimed is:

1. A communications system, comprising:
an interconnected computer network;
a servicing infrastructure for said interconnected computer network;
a plurality of users associated with said interconnected computer network;
a graphical user interface advertising component; and
an interactive computer readable medium program accessed through said network by at least a portion of said plurality of users, said interactive computer readable program comprising at least one widget to enable communication for said at least a portion of said plurality of users,
wherein said graphical user interface advertising component is embedded by one of said plurality of users into said interactive computer readable medium program for viewing by another of said plurality of users.

2. The communications system of claim 1, wherein said graphical user interface advertising component is configured to provide a complimentary interactive service to said users via said at least one widget.

3. The communications system of claim 1, wherein said at least one widget is configured to facilitate a telephonic conversation.

4. The communications system of claim 1, wherein said at least one widget is configured to facilitate a multiplayer game.

5. The communications system of claim 1, wherein said at least one widget comprises an electronic business card, wherein contact from prospective customers is directly provided via a communications network.

6. The communications system of claim 1, wherein said at least one widget comprises a mobile phone contact system, wherein said contact system comprises:
an uploaded image originating from a first mobile phone to a second mobile phone;
a downloaded image onto said second mobile phone of said uploaded image from said first mobile phone;
an interactive link contained in said downloaded image located upon said second mobile phone to said first mobile phone; and
a communications interconnection between said first mobile phone and said second mobile phone.

7. The communications system of claim 1, wherein said at least one widget comprises a group calendar that is configured to be automatically synchronized to a mobile phone associated with each of said at least a portion of said plurality of users.

8. The communications system of claim 1, wherein said at least one widget comprises an impromptu meeting room.

9. The communications system of claim 1, wherein said graphical user interface advertising component is selected from an inventory of advertising components provided by said servicing infrastructure.

10. The communications system of claim 1, wherein said graphical user interface advertising component is configured to provide at least a portion of revenues received by said servicing infrastructure to said one of said plurality of users that embedded said graphical user interface advertising component into said interactive computer readable medium program.

11. The communications system of claim 1, wherein said servicing infrastructure provides authentication of said plurality of users and interconnections between said plurality of users.

12. A method of using a communications system, comprising:
accessing an interconnected computer network by a plurality of users of said network;
hosting an interactive computer readable medium program by one of said plurality of users, said interactive computer readable medium program comprising at least one widget to enable communication for at least a portion of said plurality of users;
embedding a graphical user interface advertising component into said interactive computer readable medium program;
servicing said interactive computer readable medium program by a backend servicing infrastructure;
viewing said interactive computer readable medium program by another of said plurality of users; and
interacting with said graphical user interface advertising component by said another of said plurality of users.

13. The method of claim 12, further comprising:
sponsoring said widget by said backend servicing infrastructure via said graphical user interface advertising component.

14. The method of claim 12, wherein said servicing comprises authenticating said users and interconnecting said users.

15. The method of claim 12, wherein said widget comprises an electronic business card, wherein contact from prospective customers is directly provided via a communications network.

16. The method of claim 12, wherein said widget is configured to facilitate one of a telephonic conversation, a multiplayer game, or an impromptu meeting room.

17. A computerized method for displaying one or more widgets to enable communication between users, the method comprising:
uploading an image originating from a first mobile phone to a second mobile phone;
downloading said image from said first mobile phone onto said second mobile phone;
linking said second mobile phone to said first mobile phone via a computerized link embedded in said image; and
interconnecting said first mobile phone to said second mobile phone.

18. The method of claim 17, further comprising automatically synchronizing a group calendar between the first and second mobile phones.

19. The method of claim 17, wherein at least a portion of the image is associated with a widget that enables communication between the first mobile phone and the second mobile phone.

20. The method of claim 19, wherein the widget comprises a mobile phone contact system.
